(19) United States
(12) Patent Application Publication
(10) Pub. No.: US 2011/0066492 A1
(43) Pub. Date: Mar. 17, 2011

(54) INFORMATION PROCESSING SYSTEM, INFORMATION PROCESSING METHOD, AND COMPUTER PROGRAM

(76) Inventors: Masahide Sumiyoshi, Tokyo (JP); Hideo Nagasaka, Kanagawa (JP); Tadaaki Kimijima, Tokyo (JP)

(21) Appl. No.: 12/858,133

(22) Filed: Aug. 17, 2010

(30) Foreign Application Priority Data
Sep. 14, 2009 (JP) P2009-212081

(51) Int. Cl. G06Q 30/00; G09G 5/00

(52) U.S. Cl. 705/14.49; 345/634

(57) ABSTRACT

An information processing system includes: a user image storage section that stores a plurality of user images; an image reproducing section that reproduces an image; an image selecting section that selects an image to be reproduced from the plurality of user images stored in the user image storage section; an advertisement image acquiring section that acquires an advertisement image matched with the user image selected by the image selecting section and containing link information to related advertisement information; and a control section that merges the user image selected by the image selecting section into a user information display region in the advertisement image acquired by the advertisement image acquiring section, causes the image reproducing section to reproduce the merged image, and provides advertisement information corresponding to one piece of link information contained in the advertisement image according to selection of that piece of link information.

### BACKGROUND OF THE INVENTION

1. Field of the Invention

The present invention relates to an information processing system, an information processing method, and a computer program, which process visible information, such as still images and moving images. More particularly, the invention relates to an information processing system, an information processing method, and a computer program, which add a value to a user image, such as a picture or moving image, and reproduce the value-added user image.

2. Description of the Related Art

Recently, personal information devices, such as personal computers (PCs), personal digital assistants (PDAs), cellular phones, and portable media players, are becoming popular, and are widely used in daily life as well as in industrial activities. Available applications for those kinds of information devices include saving and reproduction of contents mainly intended for personal use, such as user images like still images and moving images captured by a digital camera, or music pieces.

For example, there have been proposed various kinds of image management software to organize and retrieve still images and moving images stored in a local disk, loaded into a PC, according to a subject and the imaging environment, to easily edit such still images and moving images to create a DVD (Digital Versatile Disc), and to add effects, such as sound effects and comments to such still images and moving images and upload the resultant images a content sharing site. At present there are numerous content sharing sites are present on the Internet, or most of social networking services (SNS) provide content sharing capability.

Methods of viewing various kinds of contents, such as still images and moving images captured by a user's own digital camera include a method of reading and reproducing contents from a local disk using image management software, and a method of downloading contents from a content sharing server on the Internet, such as a content sharing site. In the latter case, the server which has received a content retrieval request from a PC of an individual user (i.e., client) can process the content retrieval request by further using an external program or a separate server, and return generated information.

Generally, image management software allows a user to view, or reproduce, contents to which the user has authority to access and which are stored on a local disk in a PC, a remote disk outside a PC, or the like. For example, the image management software displays a list of thumbnails of viewable contents and allows the user to select (click) a desired thumbnail such that the corresponding contents is reproduced on the entire screen. Some ways of displaying a list of thumbnail images include a calendar view to sort images according to image capturing dates and a map view to sort images according to image capturing locations in addition to the general folder view (see, for example, JP-A-2006-107260 (Patent Document 1)). One example of image management software is “PMB (Picture Motion Browser)” provided by Sony Corporation, and one example of music management software is “SONICSTAGE (Registered Trademark by Sony Corporation)”.

There has been a proposal on a picture processing apparatus which automatically selects a template to paste a picture image in at the time of printing out a picture or displaying a picture (see, for example, JP-A-2006-155181 (Patent Document 2)). The apparatus can enhance the visual effect of a picture, or display additional information to a picture to add a value thereto.

There also is a proposal on an information processing method which stores news information on politics, economy, sports, etc. corresponding to time scale information on the time a picture image has been captured, as added information, in an extended area in an image file based on the time scale information (see, for example, JP-A-2003-52007 (Patent Document 3)).

### SUMMARY OF THE INVENTION

It is desirable to provide an information processing system, an information processing method, and a computer program, which are excellent in processing visible information, such as still images and moving images.

It is also desirable to provide an information processing system, an information processing method, and a computer program, which are excellent in adding a value to a user image, such as a picture or moving image, captured by a user with a digital camera, and reproducing the value-added user image.

According to an embodiment of the present invention, there is provided an information processing system including:

a user image storage section that stores a plurality of user images;

an image reproducing section that reproduces an image;

an image selecting section that selects an image to be reproduced from the plurality of user images stored in the user image storage section;

an advertisement image acquiring section that acquires an advertisement image matched with the user image selected by the image selecting section and containing link information to related advertisement information; and

a control section that merges the user image selected by the image selecting section into a user information display region in the advertisement image acquired by the advertisement image acquiring section, causes the image reproducing section to reproduce the merged image, and provides advertisement information corresponding to one piece of link information contained in the advertisement image according to selection of that piece of link information.

The term “system” used herein means a logical aggregation of a plurality of apparatus (or functional modules which achieve specific functions), regardless of whether the individual apparatuses or functional modules are located in a single casing.

The information processing system may be configured so that when the advertisement image acquired by the advertisement image acquiring section includes a moving image, the control section makes it possible to change the user image to be merged into the user information display region according to a reproduction progress time for the moving image, and merges the user image into the user information display region to be reproduced.

The advertisement image including the moving image may have a user information display region defined frame by frame.

The information processing system may be configured so that when the image selecting section simultaneously selects a plurality of user images, the control section sequentially reproduces the plurality of user images in the user information display region in a slideshow.

The information processing system may be configured so that when the user image selected by the image selecting section is a moving image, the control section merges the selected user image as a moving image into the user information display region to be reproduced.

The information processing system may be configured so that the user image storage section stores user information on a user whose user image is to be reproduced, the advertisement image has a target user condition on a user who is to be provided with information, and the advertisement image acquiring section acquires an advertisement image having a target user condition fulfilling the user information of the user image selected by the image selecting section.

The information processing system may be configured to include a user-side information device having the user image storage section, the image reproducing section, the image selecting section, the advertisement image acquiring section, and the control section, and an advertisement distribution server that distributes a plurality of advertisement images. The advertisement image acquiring section acquires that in the advertisement images distributed by the advertisement distribution server which is matched with the user image selected by the image selecting section.

The information processing system may be configured to include a user-side information device having the image reproducing section and the control section, and an advertisement distribution server that has the user image storage section for storing a user image uploaded from the user-side information device, the image selecting section, and the control section, and distributes a plurality of advertisement images. The advertisement image acquiring section acquires that in the plurality of advertisement images which is matched with the user image selected by the image selecting section, and the control section causes the image reproducing section in the user-side information device to reproduce an advertisement image merged with the user image.

The information processing system may be configured to include a user-side information device having the image reproducing section and the control section, and a content sharing server that has the user image storage section for storing a user image uploaded from the user-side information device, and the image selecting section, and an advertisement distribution server that distributes a plurality of advertisement images. The control section causes one of the user-side information device, the content sharing server and the advertisement distribution server to perform a process of merging a user image into a user information display region of an advertisement image.

According to another embodiment of the invention, there is provided an information processing method including:

a user image storage step of storing a plurality of user images;

an image selecting step of selecting an image to be reproduced from the plurality of user images stored in the user image storage step;

an advertisement image acquiring step of acquiring an advertisement image matched with the user image selected in the image selecting step and containing link information to related advertisement information; and

an image reproducing of merging the user image selected in the image selecting step into a user information display region in the advertisement image acquired by the advertisement image acquiring step, and reproducing the merged image on a user-side information device; and

an advertisement information providing step of providing advertisement information corresponding to one piece of link information contained in the advertisement image according to selection of that piece of link information by user.

According to still another embodiment of the invention, there is provided a computer program which is written in a computer readable manner so as to execute a process of reproducing a user image on a computer, and allows the computer to function as:

a user image storage section that stores a plurality of user images;

an image reproducing section that reproduces an image;

an image selecting section that selects an image to be reproduced from the plurality of user images stored in the user image storage section;

an advertisement image acquiring section that acquires an advertisement image matched with the user image selected by the image selecting section and containing link information to related advertisement information; and

a control section that merges the user image selected by the image selecting section into a user information display region in the advertisement image acquired by the advertisement image acquiring section, causes the image reproducing section to reproduce the merged image, and provides advertisement information corresponding to one piece of link information contained in the advertisement image according to selection of that piece of link information by user.

The computer program according to the embodiment of the invention defines a computer program which is written in a computer readable manner so as to execute a predetermined process on a computer. In other words, this computer program, when installed onto a computer, performs a cooperative operation on the computer to provide functions and effects similar to those of the foregoing information processing system.

The embodiments of the invention can provide an information processing system, an information processing method, and a computer program, which are excellent in processing visible information, such as still images and moving images.

The embodiments of the invention can also provide an information processing system, an information processing method, and a computer program, which are excellent in adding a value to a user image, such as a picture or moving image, captured by a user with a digital camera, and reproducing the value-added user image.

According to the embodiments of the invention, a user image, such as a picture or moving image, captured by a user with a digital camera, can be merged with an advertisement image to reproduce a merged image, making it possible to provide the user image added with a value according to the display contents of the advertisement image. In addition, an advertisement image contains one or more pieces of link information to related advertisement information, so that when any piece of link information contained in the advertisement image is selected by the user, the corresponding advertisement information is provided. This provides the user viewing user images with appealing product information, thereby contributing to sales promotion of commodities.

According to the embodiment of the invention, it is possible to change a user image to be merged into the user information display region according to a reproduction progress time for an advertisement image including a moving image. It is also possible to merge a user image into the user information display region which is defined frame by frame, and reproduce the merged image.

Moreover, it is possible to sequentially merge a plurality of user images, simultaneously selected, into the user information display region of an advertisement image, and sequentially reproduce the merged images in a slideshow.

Further, it is possible to merge a user image including a moving image into the user information display region of an advertisement image as a moving image.

Furthermore, it is possible to merge user information of a user image into an advertisement image having a target user condition fulfilling the user information, and reproduce the merged image.

Other objects, features and advantages of the invention may best be understood by reference to the following detailed description of embodiments of the invention along with the accompanying drawings.

### BRIEF DESCRIPTION OF THE DRAWINGS

FIG. 1 is a diagram showing how to paste a user image to an advertisement image to introduce a commodity, and reproduce the resultant image;

FIG. 2A is an exemplary diagram illustrating process procedures of merging a user information display region and an advertisement image display region into one display screen;

FIG. 2B is a diagram showing an advertisement image displayed in the advertisement image display region;

FIG. 3 is a flowchart illustrating process procedures for distributing an advertisement image from an advertisement distribution server, and executing an image merging process of merging the advertisement image with a user image on a user's information device;

FIG. 4 is a flowchart illustrating process procedures for merging a user image with an advertisement image on an advertisement distribution server, and distributing the merged image to a user's information device;

FIG. 5 is a flowchart illustrating process procedures for merging a user image uploaded to a content sharing site with an advertisement image provided from an advertisement distribution server, and distributing the merged image to a user's information device;

FIG. 6 is a diagram showing an example of the configuration of a user's information device which displays a user image; and

FIG. 7 is a diagram showing an example of the configuration of an advertisement distribution server or a server provided at a content sharing site.

### DESCRIPTION OF THE PREFERRED EMBODIMENTS

Embodiments of the present invention will be described below with reference to the accompanying drawings.

As mentioned above, user images, such as still images and moving images, captured by a digital camera can be reproduced with image management software. According to an embodiment of the invention, an advertisement image is pasted at the time of reproducing user images, such as pictures and moving images, captured by a user with a digital camera.

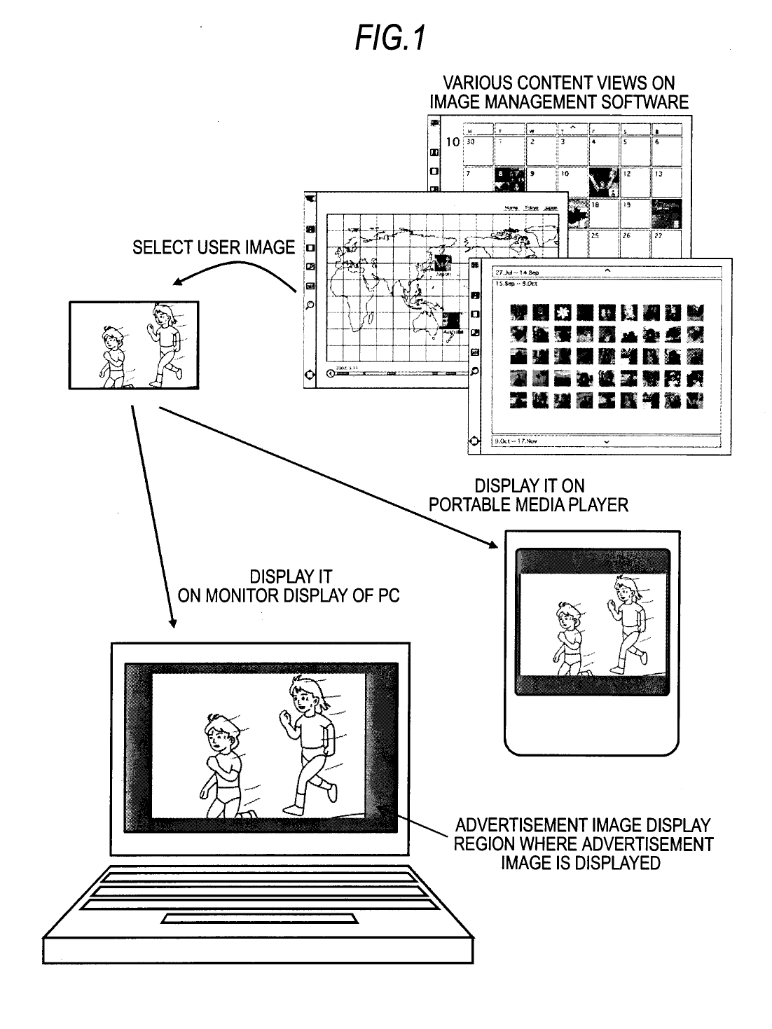

FIG. 1 shows how to paste a user image to an advertisement image to introduce a commodity, and reproduce the resultant image.

The image management software displays a list of thumbnails of contents, which a user can reproduce, in an arbitrary view form like a folder view, calendar view or map view. It is assumed that the user selects (clicks) a desired thumbnail from the list, or that a user image to be reproduced is automatically selected every predetermined time interval not depending on a user action. Although only a single user image is selected in the illustrated example, a plurality of user images may be selected simultaneously.

A target for reproduction of a user image is, for example, a portable media player or the monitor display of a PC. A user information display region which is used to display a user image, and an advertisement image display region which is used to display an advertisement image are allocated in the display screen of such a device. In the illustrated example, the advertisement image display region is allocated to the peripheral portion of the display screen so as to look like a “frame”, and the user information display region is allocated therewithin. It is to be noted however that the subject matter of the invention is not limited to a specific way of allocating those regions.

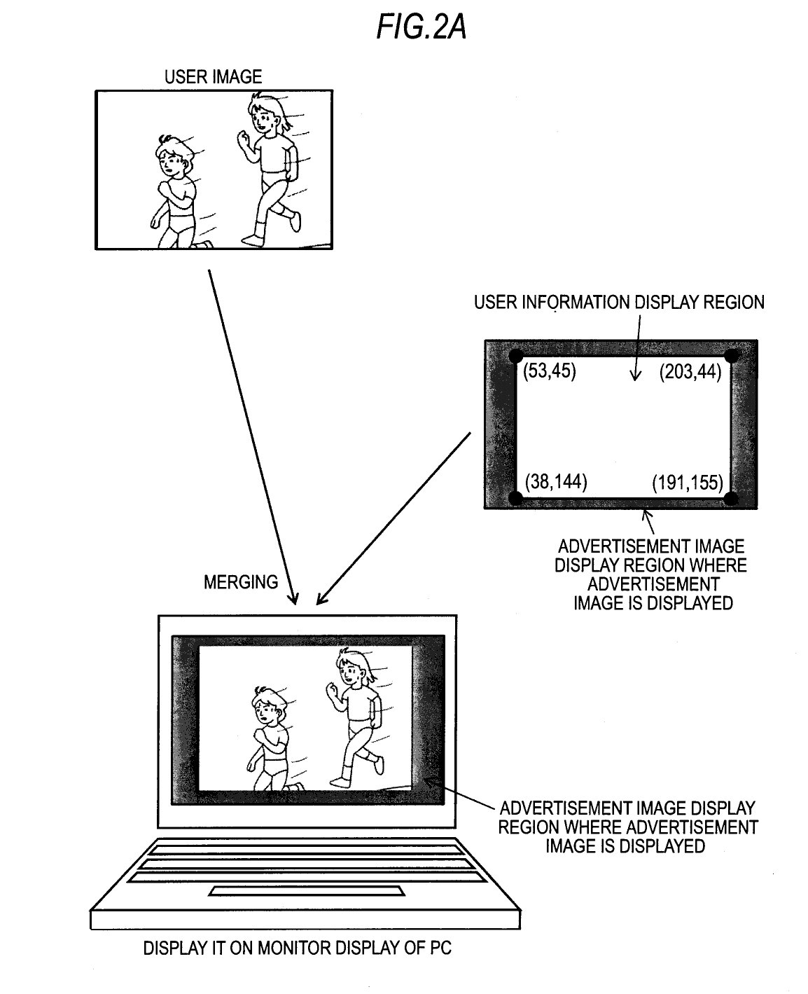

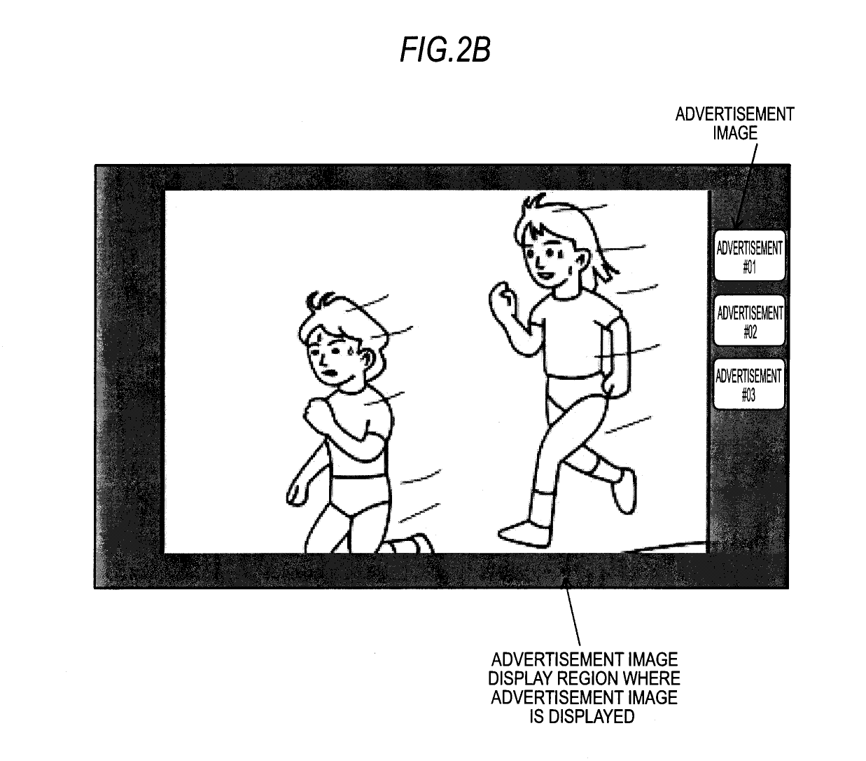

FIG. 2A exemplarily illustrates process procedures of merging the user information display region and the advertisement image display region into one display screen.

A user image to be displayed in the user information display region is stored in, for example, an information device where the user image is displayed, such as a PC or a portable media player, or is provided at a content sharing site, and can be acquired using image management software. A method of selecting a user image to be displayed from multiple user images is optional; a user image to be displayed may be selected from a list of thumbnails by a user action, or may be selected automatically. A user image to be used may be subjected to enlargement, reduction, cutting or the like, so that the user image fits in the size of the user information display region.

An advertisement image to be displayed in the advertisement image display region is provided by a manufacturer or seller of a commodity, or by an advertiser who has a business contract with the manufacturer or seller. The description will be given on the assumption that an advertisement image is provided from an advertisement distribution server set on the Internet. Link information to related advertisement information is embedded in an advertisement image. It is to be noted however that the subject matter of the invention is not limited to a specific mode of providing an advertisement image.

FIG. 2B shows an advertisement image displayed in the advertisement image display region. An advertisement image provided from the advertisement distribution server includes a moving image file or a still image file. In the illustrated example, the advertisement image display region is located at the peripheral portion of the display screen, and a user image is merged into the user information display region located at a center portion. Region coordinate information which specifies a position where a user image is pasted is set in an advertisement image. In other words, the region coordinate information defines the advertisement image display region and the user information display region. When the advertisement image display region is rectangular as shown in FIG. 2B, the coordinates of the vertexes (53, 45), (203, 44), (38, 144) and (191, 155) is the region coordinate information. When an advertisement image includes a moving image, it is assumed that the user information display region is defined frame by frame. An advertisement image is provided with an anchor in which link information to advertisement information, such as detailed information on a commodity to be advertised or related information thereof is embedded. The link information is described in, for example, the URL (Uniform Resource Locator) form (well-known form).

A user image is merged into the user information display region, designated by the region coordinate information, for a moving image or still image file provided from the advertisement distribution server, and the merged image is displayed on the monitor display. When a plurality of user images are selected simultaneously, the user images may be sequentially displayed in a slideshow, for example. When a user image selected is a moving image, the user image is merged as a moving image into the user information display region of the advertisement image. When the advertisement image includes a moving image, the user information display region is defined frame by frame, so that a user image to be merged is merged into the user information display region in such a way as to be changeable according to the progress time of reproduction of the moving image.

Designating an anchor in an advertisement image by clicking a mouse or the like jumps to a page of advertisement information, such as detailed information on a commodity or related information thereof which is specified by the link information embedded in the anchor.

When an advertisement image to be displayed in the advertisement image display region includes a moving image, a user image to be merged has only to be merged into the user information display region in such a way as to be changeable according to the reproduction progress time. For example, the user information display region (i.e., region coordinate information) should be defined and saved for each frame of a moving image.

When the user selects a plurality of user image (or a plurality of user images are automatically selected by the system), the user images may be displayed in the user information display region in a slideshow.

There are, for example, three variations available for the image merging process of coupling a user image and an advertisement image, and a distribution location for an advertisement image.

(1) Method of distributing an advertisement image from an advertisement distribution server, and merging the advertisement image with a user image on a user's information device

For example, a user image managed by image management software and an advertisement image distributed from the advertisement distribution server are merged with each other on a user's PC.

(2) Method of merging of a user image and an advertisement image on a single advertisement distribution server, and distributing the merged image to a user's information device

For example, a user image uploaded to a content sharing site is merged with an advertisement image provided within the content sharing site, and the merged image is distributed to a user's information device. In addition, a reproduction which is distributed in a streaming form at a dynamic-image sharing site is reproduced within the advertisement image.

(3) Method of merging a user image managed by one server and an advertisement image stored in another server on an arbitrary server, and distributing the merged image to a user's information device

For example, a user image uploaded to one content sharing site is merged with the an advertisement image at on another content sharing site or a server, and the merged image is distributed to the user's information device.

The methods (1) to (3) will be described in detail below.

(1) Method of distributing an advertisement image from an advertisement distribution server, and merging the advertisement image with a user image on a user's information device

In realizing this method, the advertisement distribution server manages information shown in Table 1 below for individual advertisement images to be provided. Information shown in Table 2 below is managed on a user's information device (client).

TABLE 1
Information to be Managed on Advertisement Distribution Server

| | | priority |
|---|---|---|
| information | details of information | order |
| S1: advertisement | type of moving image or still | essential |
| image | image | |
| S2: merging region | region coordinate information | essential |
| S3: medium to be | type of moving image or still | essential |
| merged | image | |
| S4: link | URL | essential |
| information | | |
| S5: target user | user profile, purchased | optional |
| condition | product, management | |
| | application to be displayed, | |
| | etc. | |

TABLE 2
Information to be Managed on User's Information Device

| | | priority |
|---|---|---|
| information | details of information | order |
| C1: user image to be | image selected using image | essential |
| merged with | management software, or image | |
| advertisement image | selected by arbitrary method | |
| C2: user | user profile, purchased | optional |
| information | product, etc. | |

The “target user condition (S5)” in Table 1 is an item describing information for designating a user with whom an advertiser wants to provide the advertisement image (i.e., target for the advertisement of a commodity), and whether or not to include the management information is optional. The “user information (C2)” in Table 2 is an advertisement for describing user attribute information, such as the profile of the user who reproduces a user image (C1) like a moving image or a picture, or commodity purchase history, and whether or not to include the management information is optional. C2 is the condition for determining an advertisement image to be merged, and is collated with S5 at the time of reproducing the user image (to be described later).

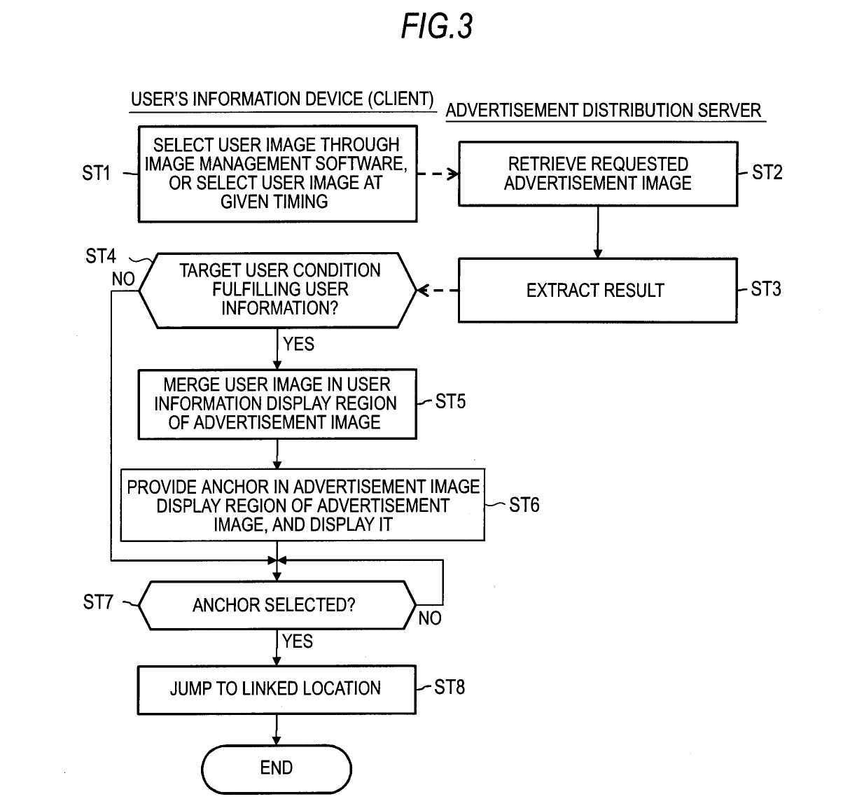

FIG. 3 illustrates process procedures for distributing an advertisement image from an advertisement distribution server, and executing an image merging process of merging the advertisement image with a user image on a user's information device in the form of flowchart.

First, when a user image is selected on the user's information device (step ST1), a request for an advertisement image is given to the advertisement distribution server. A method of selecting a user image to be displayed from multiple user images is optional; a user image to be displayed may be selected from a list of thumbnails by a user action, or may be selected automatically.

Meanwhile, in response to the request, the advertisement distribution server retrieves the requested advertisement image (step ST2), and outputs a retrieval result (step ST3). The retrieval result contains the items S1 to S5 given in the Table 1 for the advertisement image in question.

Upon reception of the retrieval result (S1-S5) from the advertisement distribution server, the user's information device collates the “target user condition (S5)” for the transmitted advertisement image (S1) with the “user information (C2)” to determine whether the advertisement image (S1) fits to be merged with the user information selected in step ST1 (step ST4).

When the determination is affirmative (Yes in step ST4), the user image (C1) selected in step ST1 is merged with the advertisement image (S1) retrieved in step ST2 (step ST5). Region coordinate information (S2) is set as management information in the advertisement image, and the user's information device performs a process of pasting the user image into the user information display region which is specified by the region coordinate information. An anchor in which link information to a page of advertisement information describing detailed information on a commodity to be advertised or related information thereof is embedded is provided at a proper location in the advertisement image, and is displayed on the monitor display (step ST6).

When the user selects the anchor in the advertisement image on the display screen by, for example, clicking with a mouse cursor (Yes in step ST7), jump is made to the page of the advertisement information, such as detailed information on a commodity or related information thereof specified by the link information embedded in the anchor (step ST8).

(2) Method of merging of a user image and an advertisement image on a single advertisement distribution server, and distributing the merged image to a user's information device

In realizing this method, the advertisement distribution server manages information shown in Table 3 below. The management information contains items S1 to S5 for each advertisement image, and items C1 and C2 for each user who is to be provided with the advertisement image.

TABLE 3
Information to be Managed on Advertisement Distribution Server

| | | priority |
|---|---|---|
| information | details of information | order |
| S1: advertisement | type of moving image or still | essential |
| image | image | |
| S2: merging region | region coordinate information | essential |
| S3: medium to be | type of moving image or still | essential |
| merged | image | |
| S4: link | URL | essential |
| information | | |
| S5: target user | user profile, purchased | optional |
| condition | product, management | |
| | application to be displayed, | |
| | etc. | |
| C1: user image to be | image selected using image | essential |
| merged with | management software, or image | |
| advertisement image | selected by arbitrary method | |
| C2: user | user profile, purchased | optional |
| information | product, etc. | |

The “target user condition (S5)” in Table 3 is an item describing information for designating a user with whom an advertiser wants to provide the advertisement image (i.e., target for the advertisement of a commodity), and whether or not to include the management information is optional. The “user information (C2)” in Table 3 is an advertisement for describing user attribute information, such as the profile of the user who reproduces a user image (C1) like a moving image or a picture, or commodity purchase history, and whether or not to include the management information is optional. C2 is the condition for determining an advertisement image to be merged, and is collated with S5 at the time of reproducing the user image (to be described later).

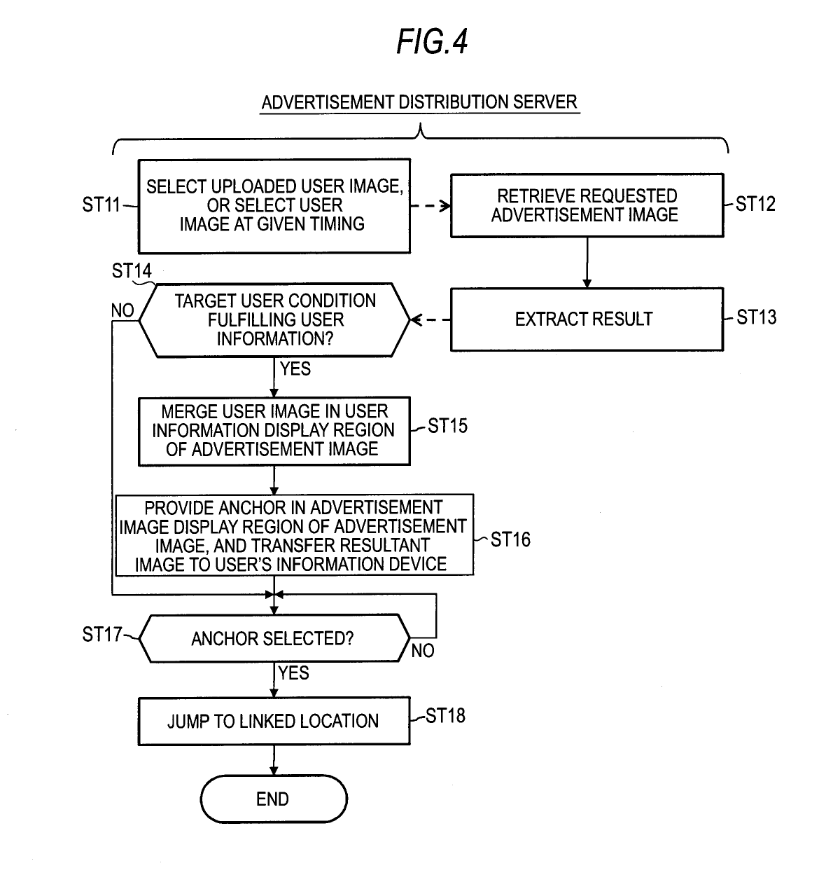

FIG. 4 illustrates process procedures for merging a user image with an advertisement image on the advertisement distribution server, and distributing the merged image to the user's information device.

The advertisement distribution server first selects a user image uploaded from the user's information device (step ST11). A method of selecting a user image to be displayed from uploaded multiple user images is optional; a user image to be displayed may be selected from a list of thumbnails by a user action, or may be selected automatically.

Next, the advertisement distribution server retrieves the requested advertisement image (step ST12), and outputs a retrieval result (step ST13). The retrieval result contains the items S1 to S5 given in the Table 3 for the advertisement image in question.

Next, the advertisement distribution server collates the user image (C1) selected in step ST11 with the target user condition (S5) for the advertisement image (51) output in step ST13 to determine whether the advertisement image (S1) fits to be merged with the user image (C1) (step ST14).

When the determination is affirmative (Yes in step ST14), the user image (C1) selected in step ST11 is merged with the advertisement image (S1) retrieved in step ST12 (step ST15). Region coordinate information (S2) is set as management information in the advertisement image, and the advertisement distribution server performs a process of pasting the user image into the user information display region which is specified by the region coordinate information. An anchor in which link information to detailed information on a commodity to be advertised or related information thereof is embedded is provided at a proper location in the advertisement image. Then, the advertisement distribution server transfers the user image added with the advertisement image to the information device of the associated user (step ST16). Alternatively, after producing the user image added with the advertisement image, the advertisement distribution server does not immediately transfer the user image, but may store the user image, and transfer it at a predetermined timing such as upon reception of a transfer request from the user. In any case, upon reception of the user image with the advertisement image, the user's information device displays the user image on the monitor display.

When the user selects the anchor in the advertisement image on the display screen by, for example, clicking with a mouse cursor (Yes in step ST17), jump is made to the page of the advertisement information, such as detailed information on a commodity or related information thereof specified by the link information embedded in the anchor (step ST18).

(3) Method of merging a user image managed by one server and an advertisement image stored in another server on an arbitrary server, and distributing the merged image to a user's information device

In realizing this method, the advertisement distribution server manages information shown in Table 4 for individual advertisement images provided. A content sharing site manages the information shown in Table 5 for each user image uploaded from the user's information device.

TABLE 4
Information to be Managed on Advertisement Distribution Server

| | | priority |
|---|---|---|
| information | details of information | order |
| S1: advertisement | type of moving image or still | essential |
| image | image | |
| S2: merging region | region coordinate information | essential |
| S3: medium to be | type of moving image or still | essential |
| merged | image | |
| S4: link | URL | essential |
| information | | |
| S5: target user | user profile, purchased | optional |
| condition | product, management | |
| | application to be displayed, | |
| | etc. | |

TABLE 5
Information to be Managed on Content Sharing Site

| | | priority |
|---|---|---|
| information | details of information | order |
| C1: user image to be | image selected using image | essential |
| merged with | management software, or image | |
| advertisement image | selected by arbitrary method | |
| C2: user | user profile, purchased | optional |
| information | product, etc. | |

The “target user condition (S5)” in Table 4 is an item describing information for designating a user with whom an advertiser wants to provide the advertisement image, and whether or not to include the management information is optional. The “user information (C2)” in Table 5 is an advertisement for describing user attribute information, such as the profile of the user who reproduces a user image (C1) like a moving image or a picture, or commodity purchase history, and whether or not to include the management information is optional. C2 is the condition for determining an advertisement image to be merged, and is collated with S5 at the time of reproducing the user image (to be described later).

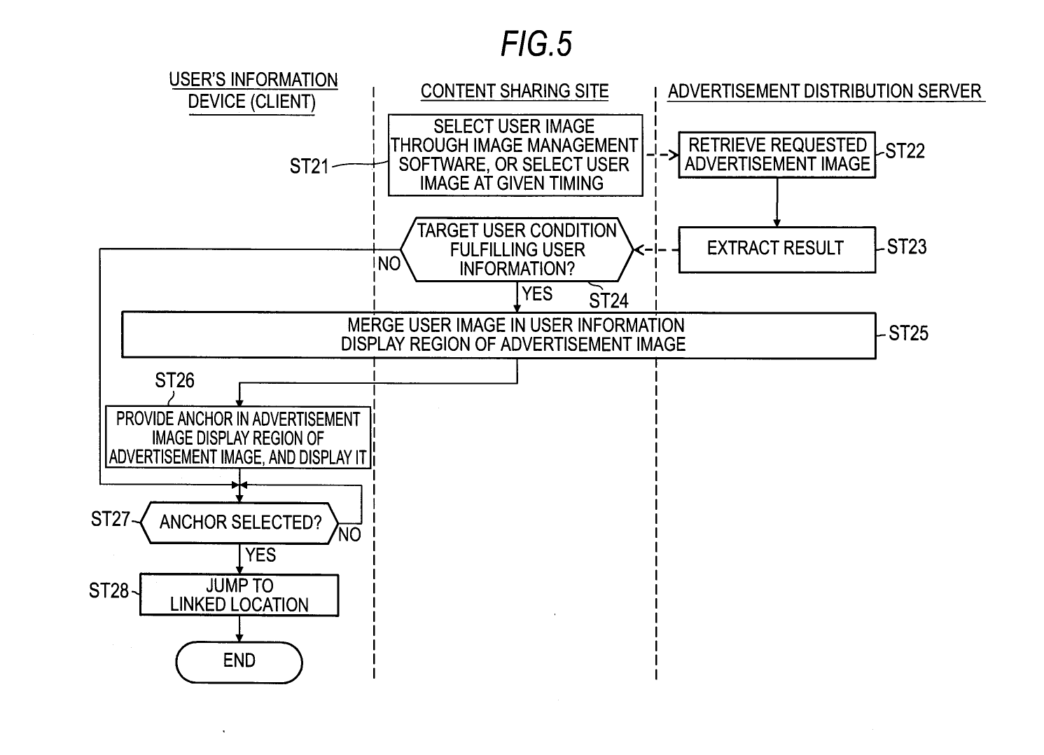

FIG. 5 illustrates process procedures for merging a user image uploaded to the content sharing site with an advertisement image provided from the advertisement distribution server, and distributing the merged image to the user's information device.

First, the content sharing site selects a user image uploaded from the user's information device (step ST21), and requests the advertisement distribution server of an advertisement image. A method of selecting a user image to be displayed from uploaded multiple user images is optional; a user image to be displayed may be selected from a list of thumbnails by a user action, or may be selected automatically.

Meanwhile, in response to the request, the advertisement distribution server retrieves the requested advertisement image (step ST22), and outputs a retrieval result (step ST23). The retrieval result contains the items S1 to S5 given in the Table 1 for the advertisement image in question.

Upon reception of the retrieval result (S1-S5) from the advertisement distribution server, the “target user condition (S5)” for the transmitted advertisement image (S1) is collated with the “user information (C2)” at the content sharing site to determine whether the advertisement image (S1) fits to be merged with the user information selected in step ST1 (step ST24).

When the determination is affirmative (Yes in step ST24), the user image (C1) selected in step ST1 is merged with the advertisement image (S1) retrieved in step ST2 (step ST25). Region coordinate information (S2) is set as management information in the advertisement image, and the image merging process is realized by pasting the user image into the user information display region which is specified by the region coordinate information (as mentioned above). An anchor in which link information to a page describing advertisement information, such as detailed information on a commodity to be advertised or related information thereof, is embedded is provided at a proper location in the advertisement image.

According to the embodiment, where the image merging process is performed is optional. For example, the image merging process may be performed at a content sharing site, or may be performed on the user's information device as done for the process procedures illustrated in FIG. 3, or may be performed on the advertisement distribution server as done for the process procedures illustrated in FIG. 4.

In any case, upon reception of the user image with the advertisement image, the user's information device displays the user image on the monitor display (step ST26).

When the user selects the anchor in the advertisement image on the display screen by, for example, clicking with a mouse cursor (Yes in step S27), jump is made to the page of the advertisement information, such as detailed information on a commodity or related information thereof specified by the link information embedded in the anchor (step S28).

According to the individual embodiments of the invention, as apparent from the above, a user image, such as a picture or a moving image captured by a user with a digital camera can be added with a value according to the display contents of an advertisement image by pasting the advertisement image at the time of reproducing the user image. Since an anchor having link information embedded therein is contained in an advertisement image superimposed on a user image, the user can jump via the anchor to a home page describing advertisement information such as detailed information on a commodity. An advertiser or a manufacturer or seller of a commodity can provide a user viewing user images with appealing product information, thereby contributing to sales promotion of commodities.

In steps ST2, ST12 and ST22 in the flowcharts respectively illustrated in FIGS. 3 to 5, there are various ways of deciding an advertisement image for a recommended commodity. For example, when a user image is selected according to the intention of a user through image management software in preceding step ST1, ST11, ST21, an advertisement image which matches with the type of a medium for the user image (e.g., either a moving image or a still image) may be a recommendable candidate. Alternatively, when a user image is selected automatically by the system, a user image which is displayed often on a user's information device may be selected, and merged with a predetermined advertisement image to be provided.

Further, some measures may be taken in merging a user image with an advertisement image in steps ST5, ST15, ST25 in the flowcharts respectively illustrated in FIGS. 3 to 5.

When a user image and an advertisement image both include a still image, for example, the user image is modified and merged in the position of the user information display region defined by the region coordinate information.

When a user image including a moving image is merged with an advertisement image including a still image of a commodity, the moving image may be modified and merged in the position of the user information display region defined by the region coordinate information.

When a user image including a still image is merged with an advertisement image including a moving image of a commodity, the user image including the still image may be modified and merged in the user information display region for each frame of the moving image.

When a user image including a moving image is merged with an advertisement image including a moving image of a commodity, the moving image of the user image may be modified and merged, for each frame, in the user information display region for each frame of the advertisement image including the moving image of the commodity.

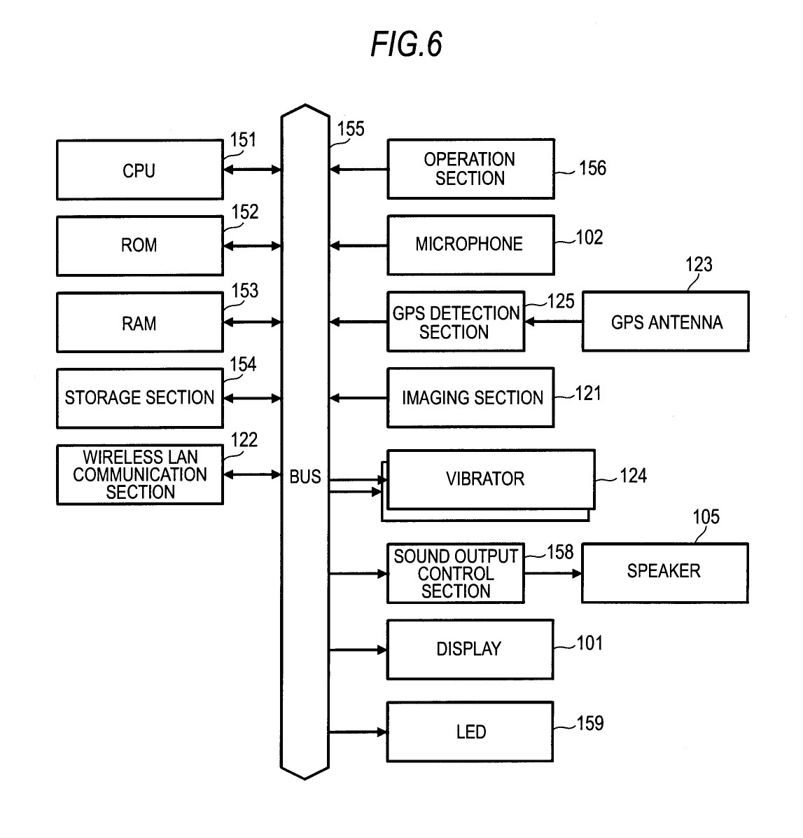

FIG. 6 is a diagram showing an example of the configuration of a user's information device, such as a cellular phone, which displays a user image.

A CPU (Central Processing Unit) 151 controls the operations of the individual sections to execute various processes according to a program stored in an ROM (Read Only Memory) 152 or a program loaded from a storage section 154 to an RAM (Random Access Memory) 153. Data needed for the CPU 151 to execute various processes is stored in the RAM 153 as needed.

The CPU 151, the ROM 152 and the RAM 153 are connected to one another by a bus 155. The bus 155 is connected with a storage section 154, a wireless LAN communication section 122, an operation section 156, a microphone 102, a GPS detection section 125, an imaging section 121, vibrators 124-1 and 124-2, a sound output control section 158, a display 101, and an LED 159. The information device can capture a moving image or a still image to be a user image using the imaging section 121.

The operation section 156 includes buttons and a jog dial or the like, and accepts an operation performed by a user. The sound output control section 158 outputs an audio sound corresponding to supplied audio information (electric signal) from a speaker 105. The LED 159 emits light to, for example, draw the attention of the user to the information device at the time of providing the user with information.

The information device shown in FIG. 6 can work as a user's information device in the process procedures illustrated in FIGS. 3 to 5 as the CPU 151 executes a predetermined application program, for example. At that time, a moving image or a still image captured by the imaging section 121 is stored as a user image in the storage section 154. A user image can be uploaded or transferred to an external server, such as one in a content sharing site, via the wireless LAN communication section 122, for example. It is also possible to acquire an advertisement image from an external advertisement distribution server, or download various contents, such as user images merged with advertisement images, via the wireless LAN communication section 122. Reproduction of a user image can be carried out on the display 101, so that the user can use the operation section 156 to select a user image to be reproduced.

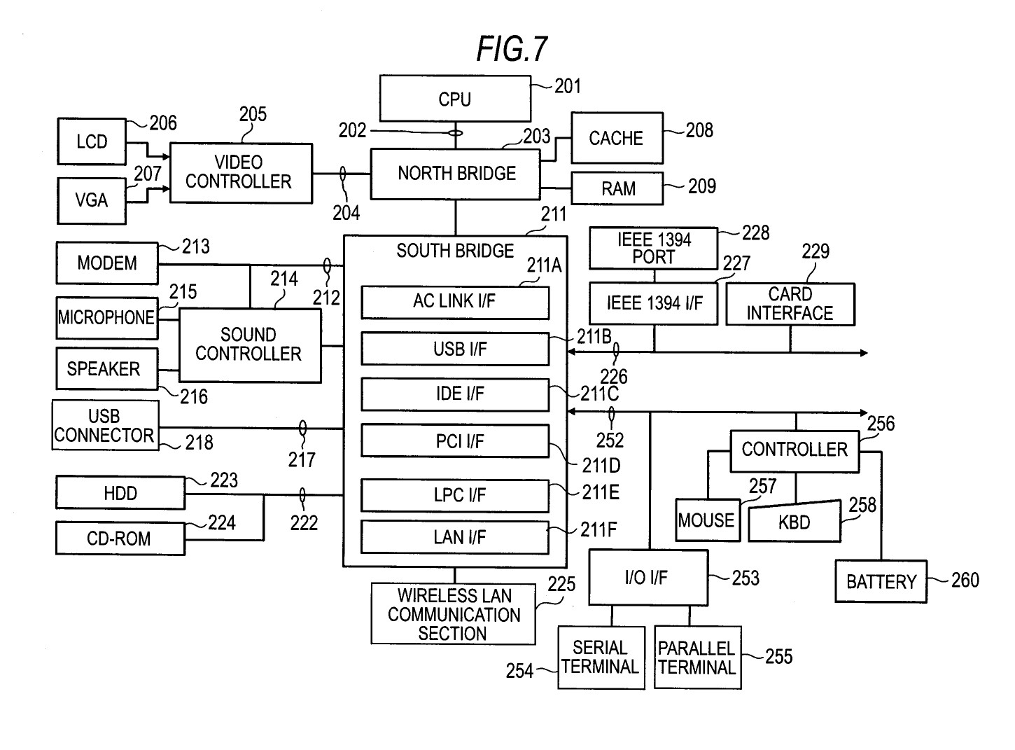

FIG. 7 shows an example of the configuration of an advertisement distribution server or a server provided at a content sharing site. Part of a user's information device is configured as shown in FIG. 7.

A CPU 201 executes various application programs under the execution environment that is provided by the operating system (OS). The OS is a program which controls the basic operations of a computer, typified by WINDOWS (Registered Trademark by Microsoft Corporation) XP or Mac OS (Registered Trademark by Apple Computer Inc).

The CPU 201 is connected to a front side bus (FSB) 202 which is further connected to a north bridge 203. The north bridge 203 has an AGP (Accelerated Graphics Port) 204 and a hub interface 210.

The north bridge 203, which is connected to a cache memory 208 and an RAM 209 or a main memory, controls operations to access those memory devices. The RAM 209 is formed by, for example, a DRAM (Dynamic RAM), and stores a program to be executed by the CPU 201, and work data needed for the operation of the CPU 201. The cache memory 208 is formed by a memory device, such as an SRAM (Static RAM), which achieves fast writing or reading, and caches or temporarily stores a program or data used by the CPU 201.

The north bridge 203 is connected to a video controller 205 via the AGP 204. The video controller 205 generates image data corresponding to data received from the CPU 201, or stores image data received from the CPU 201 into an internal video memory (not shown) directly, and displays an image corresponding to the image data in the video memory on an LCD 206 or a VGA controller 207. The LCD 206 or the VGA controller 207 displays an image, characters or the like based on the data supplied from the video controller 205. The VGA controller 207 is a display of the VGA (Video Graphics Array) type.

The north bridge 203 is connected to a south bridge 211 via the hub interface 210. The south bridge 211 incorporates an AC link interface 211A, a USB (Universal Serial Bus) interface 211B, an IDE (Integrated Drive Electronics) interface 211C, a PCI (Peripheral Component Interconnect) interface 211D, an LPC (Low Pin Count) interface 211E, an LAN interface 211F, etc. The south bridge 211 controls the input/output operations of various devices connected thereto via devices connected to an AC link bus 212, a USB bus 217, and an IDE bus 222.

The AC link bus 212 is connected with a modem 213, a sound controller 214, and the like. The sound controller 214 acquires a sound from a microphone 215, generates data corresponding to the sound, and outputs the data to the RAM 209. The sound controller 214 drives a speaker 216, and outputs a sound thereto.

A USB connector 218 is connected to the USB bus 217 so that various USB devices can be connected. A USB interface 221B transmits data to and receives data from an external device connected via the USB bus 217.

The IDE interface 211C includes two IDE controllers, namely, a primary IDE controller and a secondary IDE controller, and a configuration register (neither shown). The primary IDE controller is connected with an HDD (Hard Disk Drive) 223 via the IDE bus 222. The secondary IDE controller is electrically connected with an IDE device, such as a CD-ROM drive 224 or HDD (not shown), when the IDE device is connected to another IDE bus.

A wireless LAN communication section 225 is connected to a network via wireless LAN communication based on, for example, IEEE 802.11a/b or the like. The LAN interface 211F transmits data to and receives data from a network connected to the wireless LAN communication section 225.

An LPC bus 251 is connected with ROM 252, an I/O (Input/Output) interface 253 and a controller 256. The BIOS (Basic Input Output System) or the like is stored in an ROM (Read Only Memory) 252. The BIOS is a collection of basic input/output commands, and controls the input/output of data between the OS or the application program and a peripheral device.

The I/O interface 253 is connected with a serial terminal 254 and a parallel terminal 255, and performs serial input/output and parallel input/output with respect to devices respectively connected to those terminals. User input devices, such as a keyboard 258 and a mouse 257, can be connected to the controller 256. The controller 256 has capabilities of monitoring the terminal voltage of a battery 260 or the main power supply, and controlling the charge/discharge operation thereof.

A PCI bus 226 is connected with a card interface 229, an IEEE 1394 interface 227, and other unillustrated PCI devices. The card interface 229 supplies data supplied from an expansion card (not shown) connected to a slot 230 to the CPU 201 or the RAM 209, and outputs data supplied from the CPU 201 to the expansion card connected to the slot 230. The IEEE 1394 interface 227 transmits and receives data (data stored in a packet) conforming to the IEEE 1394 standards via an IEEE 1394 port 228.

The device shown in FIG. 7 can operate, for example, as an advertisement distribution server or a user's information device in the process procedures illustrated in FIGS. 3 to 5, or as a server in a content sharing site shown in FIG. 5 when the CPU 201 executes a predetermined application program. User images and advertisement images can be stored in the HDD 223, and uploading of a user image and transfer of an advertisement image can be carried out via the wireless LAN communication section 225. A desired user image can be selected by operating a GUI (Graphical User Interface), such as the mouse 257. It is possible to select a user image through the display screen of the VGA controller 207, and reproduction of a user image merged with an advertisement image can be carried out under control of the video controller 205.

The detailed description of the invention has been given referring to particular embodiments. However, it should be apparent to those skilled in the art that the embodiments may be modified and changed departing from the spirit or scope of the invention. That is, the present examples and embodiments are to be considered as illustrative and not restrictive and the present invention is not to be considered by reference to the scope of the appended claims.

The present application contains subject matter related to that disclosed in Japanese Priority Patent Application JP 2009-212081 filed in the Japan Patent Office on Sep. 14, 2009, the entire contents of which is hereby incorporated by reference.

What is claimed is:

1. An information processing system comprising:
a user image storage section that stores a plurality of user images;
an image reproducing section that reproduces an image;
an image selecting section that selects an image to be reproduced from the plurality of user images stored in the user image storage section;
an advertisement image acquiring section that acquires an advertisement image matched with the user image selected by the image selecting section and containing link information to related advertisement information; and
a control section that merges the user image selected by the image selecting section into a user information display region in the advertisement image acquired by the advertisement image acquiring section, causes the image reproducing section to reproduce the merged image, and provides advertisement information corresponding to one piece of link information contained in the advertisement image according to selection of that piece of link information.

2. The information processing system according to claim 1, wherein when the advertisement image acquired by the advertisement image acquiring section includes a moving image, the control section makes it possible to change the user image to be merged into the user information display region according to a reproduction progress time for the moving image, and merges the user image into the user information display region to be reproduced.

3. The information processing system according to claim 2, wherein the advertisement image including the moving image has a user information display region defined frame by frame.

4. The information processing system according to claim 1, wherein when the image selecting section simultaneously selects a plurality of user images, the control section sequentially reproduces the plurality of user images in the user information display region in a slideshow.

5. The information processing system according to claim 1, wherein when the user image selected by the image selecting section is a moving image, the control section merges the selected user image as a moving image into the user information display region to be reproduced.

6. The information processing system according to claim 1, wherein the user image storage section stores user information on a user whose user image is to be reproduced,
the advertisement image has a target user condition on a user who is to be provided with information, and
the advertisement image acquiring section acquires an advertisement image having a target user condition fulfilling the user information of the user image selected by the image selecting section.

7. The information processing system according to claim 1, further comprising:
a user-side information device having the user image storage section, the image reproducing section, the image selecting section, the advertisement image acquiring section, and the control section; and
an advertisement distribution server that distributes a plurality of advertisement images,
wherein the advertisement image acquiring section acquires that in the advertisement images distributed by the advertisement distribution server which is matched with the user image selected by the image selecting section.

8. The information processing system according to claim 1, further comprising:
a user-side information device having the image reproducing section and the control section; and
an advertisement distribution server that has the user image storage section for storing a user image uploaded from the user-side information device, the image selecting section, and the control section, and distributes a plurality of advertisement images,
wherein the advertisement image acquiring section acquires that in the plurality of advertisement images which is matched with the user image selected by the image selecting section, and
the control section causes the image reproducing section in the user-side information device to reproduce an advertisement image merged with the user image.

9. The information processing system according to claim 1, further comprising:
a user-side information device having the image reproducing section and the control section;
a content sharing server that has the user image storage section for storing a user image uploaded from the user-side information device, and the image selecting section; and
an advertisement distribution server that distributes a plurality of advertisement images,
wherein the control section causes one of the user-side information device, the content sharing server and the advertisement distribution server to perform a process of merging a user image into a user information display region of an advertisement image.

10. An information processing method comprising:
a user image storage step of storing a plurality of user images;
an image selecting step of selecting an image to be reproduced from the plurality of user images stored in the user image storage step;
an advertisement image acquiring step of acquiring an advertisement image matched with the user image selected in the image selecting step and containing link information to related advertisement information; and
an image reproducing step of merging the user image selected in the image selecting step, and reproducing the merged image on a user-side information device into a user information display region in the advertisement image acquired by the advertisement image acquiring step; and
an advertisement information providing step of providing advertisement information corresponding to one piece of link information contained in the advertisement image according to selection of that piece of link information.

11. A computer program written in a computer readable manner so as to execute a process of reproducing a user image on a computer, the program allowing the computer to function as:
a user image storage section that stores a plurality of user images;
an image reproducing section that reproduces an image;
an image selecting section that selects an image to be reproduced from the plurality of user images stored in the user image storage section;
an advertisement image acquiring section that acquires an advertisement image matched with the user image selected by the image selecting section and containing link information to related advertisement information; and
a control section that merges the user image selected by the image selecting section into a user information display region in the advertisement image acquired by the advertisement image acquiring section, causes the image reproducing section to reproduce the merged image, and provides advertisement information corresponding to one piece of link information contained in the advertisement image according to selection of that piece of link information.
